(19) United States
(12) Patent Application Publication
(10) Pub. No.: US 2024/0223029 A1
(43) Pub. Date: Jul. 4, 2024

(54) ELECTROMAGNETIC LINEAR MOTION MACHINE COMPRISING RODS ASSOCIATED WITH MAGNETIC ELEMENTS

(71) Applicant: FinX, Le Havre (FR)

(72) Inventors: Harold Guillemin, Seine-Port (FR); Vincent Randon, Etouy (FR); Lucas Comiti, Serra-di-Scopamene (FR)

(21) Appl. No.: 18/571,895

(22) PCT Filed: Jun. 28, 2022
(86) PCT No.: PCT/FR2022/051281

§ 371 Date: Dec. 19, 2023

(30) Foreign Application Priority Data
Jun. 28, 2021 (FR) FR2106939

(51) Int. Cl. H02K 1/17; H02K 33/16

(52) U.S. Cl. CPC H02K 1/17; H02K 33/16; H02K 2201/03

(57) ABSTRACT

An electromagnetic machine includes: a frame, a stator arranged to create a magnetic field, a linearly movable portion, and a linearly movable portion. The stator includes at least two stator elements facing one another. The linearly movable portion includes at least two separate rods that are movable along respective drive axes, each rod being arranged at one end of the two stator elements, and at least one magnetic element associated with the at least two rods, the at least one magnetic element being arranged between the two stator elements and being magnetically movable with respect to the at least two stator elements. The linearly movable portion further includes coupling means between the at least one magnetic element and the rods.

### CROSS-REFERENCE TO RELATED APPLICATIONS

This application is a national phase entry under 35 U.S.C. § 371 of International Patent Application PCT/FR2022/051281, filed Jun. 28, 2022, designating the United States of America and published as International Patent Publication WO 2023/275481 A1 on Jan. 5, 2023, which claims the benefit under Article 8 of the Patent Cooperation Treaty of French Patent Application Serial No. FR2106939, filed Jun. 28, 2021.

### TECHNICAL FIELD

The present disclosure relates to the field of electromagnetic machines, of the motor or generator type, the movable portion of which carries out a linear translational movement.

### BACKGROUND

From the prior art document FR3074620, there is known an electromagnetic machine comprising a stator, a movable armature and a device for mechanically connecting the movable frame to the stator, the connection device comprising a plurality of leaf springs. The stator comprises at least one first magnetic core, carrying two electrical coils, forming at least one open loop between first and second terminal ends of this first loop to define an air gap between these terminal ends. The movable armature carries two aligned permanent magnets whose polarity is the reverse of one another. When a magnetic flux is generated in the air gap, a transverse force shifts the movable armature in a first direction while causing the leaf springs to bend, opposing this movement in this first direction. Under the effect of a switching of current in the coils, the magnetic flux passing through the air gap is reversed. This results in a transverse force shifting the movable armature in a second direction. By reversing the magnetic fluxes in the opposite directions, via a switching of current in the coils, an alternating movement of the armature relative to the support is generated, the springs exerting a return force that, at certain frequencies, amplify the efficiency of the motor.

However, in the case where multiple moving armatures are desired, the form factor of this machine is a drawback.

Application EP3029819 discloses a linear actuator comprising three motors. Each motor comprises a stator and a permanent magnet rod. The three rods can be moved by way of the electromagnetic forces of the respective stators, comprising an electrical wire winding. However, the number and arrangement of the magnets is not specified, nor even the arrangement of the stator.

It is thus desirable to propose a simple solution, allowing adjustment of the frequency and amplitude of the rods, and offering a reduced form factor.

### BRIEF SUMMARY

To this end, and according to a first aspect, the present disclosure proposes an electromagnetic machine, including:
a frame,
a stator arranged to create a magnetic field, comprising at least two stator elements facing one another,
a linearly movable portion, comprising:
at least two separate rods that are movable along respective drive axes, each rod being arranged at one end of the two stator elements,
at least one magnetic element, associated with the at least two rods, the at least one magnetic element being arranged between the two stator elements and magnetically movable with respect to the at least two stator elements, and
coupling means between the at least one magnetic element and the rods.

The electromagnetic machine according to the present disclosure has the advantages of proposing a small number of elements, a reduced form factor and of allowing a reciprocating movement at high frequency, providing a high force. This arrangement also makes it possible to propose an electromagnetic machine offering a low manufacturing and maintenance cost.

A stator is understood to mean the fixed part of the electromagnetic machine. It is attached to the frame of the machine. Preferably, the stator consists of a stack of sheet metal plates made of ferromagnetic materials, preferably soft iron, and a winding of a conductive wire. The stator generates the electromagnetic field when an electric current passes through the conducting wire.

A stator element is understood to mean a part of the stator generating an electromagnetic field. Preferably, each stator element comprises a stack of sheet metal plates comprising at least two teeth. Preferably, each stator element comprises a stack of sheet metal plates comprising at least one notch. For example, the sheet metal plates can be powered by one or more coils. The stator elements are arranged in pairs or couples in order to produce one or more magnetic circuits. They are spaced apart from each other so as to insert at least one magnetic element between the teeth and able to move magnetically under the effect of the magnetic field passing through the teeth.

According to one embodiment, each stator element comprises a stack of sheet metal plates comprising three teeth, so as to produce an “E”-shaped pattern. The two notches are occupied by a winding of electrical wires. According to other embodiments, the stator elements may comprise an unlimited number of longitudinally aligned teeth.

The stator comprises, in a minimum version, only two stator elements. The stator elements are arranged so that the teeth of the two stator elements are arranged opposite to make magnetic circuits with minimum air gaps.

According to other embodiments, the stator may comprise an unlimited number of pairs of two stator elements.

The linearly movable portion comprises at least two magnetic rods, the rods being arranged on either side of the pair of stator elements. The rods may have a rectangular cross-section, preferably square, or cylindrical, preferably circular.

The movable portion further comprises at least one magnetic element intended to be moved under the effect of the magnetic field of the stator. The at least one magnetic element is connected to the two rods. Preferably, the at least one magnetic element is arranged between the two rods. The at least one magnetic element does not integrate completely into the rods. According to one embodiment, each magnetic element extends radially or perpendicularly relative to the two rods. According to a preferred embodiment, the movable portion comprises at least one magnetic element connected to two rods.

According to one embodiment of the coupling means, the means comprise:
a rod part arranged to be attached to a rod,
a magnetic element part arranged to secure the at least one magnetic element, and thus mechanically couple the at least one magnetic element to a rod.

Preferably, the rod part surrounds the outer envelope of a rod and is connected thereto by means for holding in position in order to drive the rod during the movement of the at least one magnetic element. Preferably, the magnetic element part comprises a cavity or recess in order to receive one end or a portion of the at least one magnetic element, such as a key-type mounting in a groove.

According to another embodiment of the coupling means, the means comprise a cavity or recess arranged on the circumference or on an exterior face of a rod, such as a key-type mounting in a groove.

Each magnetic element comprises at least one pair of alternating poles. Preferably, each magnetic element comprises at least two pairs of alternating poles. According to an alternative embodiment, each magnetic element comprises at least four pairs of alternating poles. Preferably, each magnetic element comprises multiple opposite magnetic poles.

A pair of poles is understood to mean a system having a north pole and a south pole. A pair of poles is preferably a magnet. Two pairs of alternating poles are understood to mean two systems as defined above arranged in inverted fashion, or so that each pole of a first pair is arranged opposite a pole of reverse polarity of the second pair, or adjacent pair.

According to one embodiment, the at least one magnetic element comprises or is at least one permanent magnet. The magnet(s) may have different geometric shapes. Preferably, each magnet has a generally rectangular shape. Preferably, each magnet has a rectangular cross-section. This embodiment has the advantage of providing a small thickness with respect to the length and/or width in order to maximize the active magnetization area. According to a first variant, each magnet is rectilinear. According to a second variant, each magnet is curved or concave.

Preferably, the linearly movable portion comprises a spacer arranged between two pairs of poles. In the case where the movable portion comprises multiple magnets, a spacer is arranged between two magnets. This feature makes it possible to define a force and/or amplitude of motion of the rods connected to the magnets. The spacers can be magnetizable or non-magnetic, depending on the desired force and amplitude.

According to another embodiment, the at least one magnetic element is made of a ferromagnetic material. The permanent magnet(s) are removed from the movable portion of the machine. The machine may further comprise at least one means for returning to position so as to return the at least one magnetic element to the initial position.

According to one alternative embodiment, the at least one magnetic element is made of a ferromagnetic material and a non-magnetic material. Thus, one magnet in two can be replaced by a magnetic core, the other is non-magnetic. The coil of the electromagnet of a stator element is mounted so as to operate in positive current only and is short-circuited in the reverse case. This allows each rod in oscillatory fashion to be alternately attracted by the electromagnetic field of the stator, then pushed back, for example, by the force of position return means, preferably a spring. Return means are described below. This embodiment makes it possible to propose a particularly simplified and inexpensive machine.

Preferably, the electromagnetic machine comprises means for guiding in translation, for example, bearings, slides and/or pads. The guiding means can cooperate with the rods, the at least one magnetic element, preferably the magnet(s), and/or the coupling means.

Preferably, the electromagnetic machine comprises sealing means of the stator and/or of the portion movable linearly relative to the external environment. For example, the electromagnetic machine comprises means for sealing the stator and/or at least two rods relative to the external environment.

The sealing means comprise rod sealing means. Preferably, two rod sealing means are associated with each rod, each means being arranged at one end of the rod. They make it possible to protect the air gap around each rod.

The sealing means must protect the machine from the saline atmosphere, the polluted atmosphere, or fresh or saline water during submersion. For example, the sealing means may be O-rings, sliding elements ensuring sealing, flexible bellows (made of elastomer or metal), or mechanical or a combination thereof. The seals may be the following: wiper seal, buffer seal, single-effect seal double-acting seal, lip seal(s) (or spi seal), spring seal. It is possible to use these seals alone or to combine them in order to obtain different functions, for example, filtering the impurities, performing a pre-sealing in order to obtain a submerged chamber and therefore lubrication of the guide linings and then another seal allowing the complete sealing.

Additionally, the machine, in particular the stator or each coiled stator element, can be made, for example, with an epoxy or silicone resin. Even more additionally, the at least two rods of the movable portion can be surrounded by an oil bath, offering the advantage of maintaining the pressure in the event of deep immersion, or of lubricating and cooling the system permanently.

Furthermore, the electromagnetic machine may comprise at least one position return means associated with at least one rod. According to one embodiment, the machine comprises a position return means for each rod. Preferably, a position return means is a resilient elastic return means, for example, a spring, preferably a metal spring, in particular made of steel. Although each rod produces a reciprocating movement, it may be beneficial to promote the kinetics of one of the two movements. In normal operation, an electromagnetic machine according to the present disclosure, having movable rods oscillating on a polar pitch or being driven to move by control electronics, does not require a return means for the movable rods. However, it may be beneficial to add to it in order to optimize the efficiency of the machine. For example, a spring could be placed at a first end of a movable rod and/or at a second end, opposite the first end, of the movable rod. This feature makes it possible to absorb the kinetic energy during a first phase of the reversal of the movement in order to store potential energy therein and then retransmit it to the mobile rod during the second phase of reversal. These return means also make it possible to avoid any uncontrolled movement of excessive amplitude, which can lead to premature wear of the machine, or to one or more movable rods unintentionally extending out from the machine. Preferably, the oscillation frequency of the rod is the same as the resonance frequency of the system, in order to consume the least possible energy to be set in motion.

According to a particular embodiment, the stator comprises at least four stator elements forming two pairs of two stator elements arranged around a longitudinal axis and extending in a circumferential or orthoradial direction relative to the longitudinal axis, and wherein the linearly movable portion comprises four rods forming two pairs of two rods. For the foregoing and for the rest of the description, a pair of stator elements associated with a pair of rods and at least one magnetic element is also called a module. The electromagnetic machine can thus comprise one or more modules.

Preferably, the at least two pairs of stator elements are spaced along a circle whose longitudinal axis is the center.

According to any type of rod, the at least two pairs of rods of the movable portion can be spaced along a circle whose longitudinal axis is the center. Preferably, the at least two rods can be spaced equidistant along a circle whose longitudinal axis is the center.

Preferably, the rods are parallel to one another and relative to the longitudinal axis.

According to any embodiment, the rods can have different shapes. According to a cross-section, each rod may have a parallelepiped, rectangular, hexagonal, cylindrical or circular shape.

Preferably, the stator elements are arranged so as to define a free central zone. The volume defined by the at least two stator elements and the at least two rods is free at the center. No part is within the central portion of the machine. This allows various advantages such as, for example:
allowing the passage of a part or a fluid (in particular heat transfer fluid) through the center,
lower volume and weight, which is important for on-board systems,
allowing better gripping of the machine during the handling thereof,
or
improving the thermal performance of the machine via better cooling.

According to a particular embodiment, the stator comprises twelve stator elements forming six pairs of stator elements, and the movable portion comprises twelve rods, forming six pairs of rods. Preferably, the linearly movable portion comprises two permanent magnets cooperating with each pair of stator elements.

Preferably, the pairs of stator elements and the associated movable portion are arranged in phase opposition in an alternating manner. Three pairs of stator elements are shifted by 180 degrees relative to the other three pairs of stator elements. Preferably, the rods move at a frequency of between 10 and 150 Hz (hertz).

The electromagnetic machine comprises power electronics and/or control means so that the movement of the rods of the movable portion is controlled in an open loop by the power electronics. Control is done by way of power electronics making it possible to undulate a voltage at different frequencies such as, for example, an inverter that can vary the effective voltage and frequency.

According to another embodiment, the machine comprises at least one sensor, such as, for example, a sensor for moving the movable portion, or a current sensor. The power electronics and/or the control means control the movement of the rods of the movable portion in a closed loop by virtue of the information from the at least one sensor.

Preferably, the machine comprises a temperature sensor so as to measure the temperature of the machine, connected directly preferably to the control electronics. It can also be protected against excessive warming thanks to a thermal fuse. These two components are preferably mounted at the periphery of the coil and advantageously at its center, since the coil is the main component diffusing the heat.

The control means make it possible to control each module independently, or in a synchronized or non-synchronized manner with other modules, and/or so as to eliminate the imbalances, for example, by controlling the oscillation of two modules in phase opposition.

According to a second aspect of the present disclosure, a mechanical assembly comprising an electromagnetic machine is provided, according to the one or more of the features of the first aspect of the present disclosure, and at least one effector mounted to the at least one of the distal ends of the at least two rods. Preferably, the effector is connected to all the distal ends of the at least two rods.

Preferably, the at least one effector comprises at least one membrane. Each membrane can be arranged coaxially to the electromagnetic machine and opposite an exterior face of the frame. Preferably, each membrane has a central opening arranged to have a fluid go through.

Preferably, the mechanical assembly comprises at least one flange arranged to hydraulically cooperate with the at least one membrane. According to one embodiment wherein the mechanical assembly comprises several membranes, each flange being associated with a single membrane.

For example, each flange may have the following combinable alternative variants:
being rigid or flexible,
possess any shape in combination with the shape of the membranes,
be solid, or pierced at the center, for example, allowing a Venturi effect by virtue of the speed difference,
have voids and/or asperities and/or lips for various uses (corrosion resistance, pressure rise, self-priming, etc.), and
be composed of specific materials (marine, food-safe, biocompatible, for hydrocarbons, etc.),
the flange may itself be surrounded by two or more membranes.

According to a particular example, the single flange can be the wall of a hull of a boat or a nautical vehicle (a cone, submarine, etc.).

According to a particular embodiment, the mechanical assembly comprises an electromagnetic machine extending along a longitudinal axis, the machine comprising one or more of the features of the first aspect of the present disclosure, the machine comprising:
a stator comprising at least four stator elements forming two pairs of stator elements,
a linearly movable portion, comprising at least four rods forming two pairs of two rods,
the assembly comprising at least one effector mounted to the at least one of the distal ends of at least two rods.

Preferably, a magnetic element is associated with a pair of two rods. According to one embodiment, at least two magnetic elements are associated with a pair of two rods.

According to a particular embodiment, the mechanical assembly comprises an electromagnetic machine extending along a longitudinal axis, the machine comprising:
a frame,
a stator arranged to create a magnetic field, comprising at least four stator elements, forming two pairs of stator elements, arranged around the longitudinal axis and extending in a circumferential or orthoradial direction relative to the longitudinal axis,
a linearly movable portion, comprising at least four rods forming two pairs of two rods, at least two magnetic elements, each magnetic element being associated with a pair of rods and arranged between two stator elements so as to be magnetically movable, and coupling means for connecting each magnetic element to its pair of rods,
the assembly comprising at least one effector mounted to the at least one of the distal ends of at least two rods.

Preferably, the at least four rods comprise at least two upstream rods and at least two downstream rods, the assembly comprising an upstream membrane connected to the distal ends of the at least two upstream rods, and a downstream membrane connected to the distal ends of the at least two downstream rods.

This allows, for example, a hydraulic thruster whose liquid flow propelled by the latter is less turbulent relative to the flow of the known thrusters such as motors equipped with a propeller.

Preferably, the at least one magnetic element may be at least one pair of alternating poles, for example, one or more permanent magnets.

Preferably, the assembly comprises at least one flange covering all or part of a transverse face of the electromagnetic machine. The at least one flange may be solid or pierced, in particular at the center of the flange. According to alternative embodiments, the at least one flange can be rigid, or flexible, and/or have certain shapes and/or recesses and/or asperities. The at least one flange may further comprise lips for various uses, for example, corrosion resistance, or in order to allow rise in pressure. For example, the at least one flange may be made of specific materials, such as marine, food-safe, biocompatible, or hydrocarbons.

According to one embodiment, the assembly comprises at least one upstream flange connected to an upstream face of the frame and arranged opposite the upstream membrane, and at least one downstream flange connected to a downstream face of the frame and arranged opposite the downstream membrane.

During actuation, the reciprocating movement of the rods causes the undulation of the membrane(s). Each membrane is used to transform the mechanical energy supplied by the motor into hydraulic energy. Each membrane has a cylindrical shape or preferably a disc or elliptical shape. It is composed of a solid armature, advantageously metallic, and an undulating part made of flexible materials, preferably elastomer derivatives (rubber, EPDM, PU, Nitrile, etc.). The membrane may be of any shape.

Preferably, each membrane has a central opening that is preferably circular or elliptical. Preferably, each flange has a tubular section arranged coaxially to the longitudinal axis of the machine and extending through the central opening of the associated membrane. The diameter of the tubular section is strictly less than the diameter of the central opening. The tubular section makes it possible to produce a Venturi effect for the flow of the fluid passing through the center of the mechanical assembly.

According to a particular embodiment, the assembly may comprise at least two upstream membranes and/or at least two downstream membranes. The upstream and/or downstream membranes may have movements phase-shifted to each other, preferably the phase shift is 180° (degrees).

According to another particular embodiment, at least two rods of a pair extend both upstream and downstream of the frame, the assembly comprising at least two effectors, an effector connected to the upstream distal ends of the rods and an effector connected to the downstream distal ends of the rods. In this embodiment, at least two rods pass through the frame and extend upstream and downstream of the frame, which may have at least one seal.

Preferably, the assembly comprises an upstream cover, arranged upstream of the upstream membrane, and a downstream cover, arranged downstream of the downstream membrane. Each cover is attached to the frame of the electromagnetic machine coaxially to the longitudinal axis of the machine, for example, by means of longitudinal arms connecting each cover to the frame of the machine. Preferably, the face of the cap facing the membrane has a surface substantially identical to the surface of the membrane. The volume delimited longitudinally by a cover and a flange defines a compression chamber, or a propulsion chamber. Both when stopped and while the machine is in operation, each membrane is located in a propulsion chamber. The liquid set in motion by a membrane enters the propulsion chamber beforehand through the circumferential zone of the compression chamber, for example, between longitudinal arms connecting the cover to the frame of the machine.

For the foregoing and for the rest of the description, compression chamber and propulsion chamber refer to the same definition, so that either of the expressions can be used without distinction.

The volume propelled by the upstream membrane is expelled into the central free area of the machine. The downstream cover further comprises an opening whose cross-section is at least equal to the cross-section of the free central area. The volume propelled by the downstream membrane is expelled into the opening of the downstream cover.

Two compression chamber configurations are possible:
in series, so that the inlet flow of the downstream compression chamber is connected to the outlet flow of the upstream compression chamber via the central free zone of the machine,
in parallel, so that each compression chamber has an inlet flow specific thereto, each flow entering the compression chamber via an opening or a radial zone upstream and/or downstream and/or above and below the membrane.

It is possible to combine these two solutions: a central flow passing through the free central zone and a radial flow can supply the downstream compression chamber.

Each compression chamber corresponds to at least one liquid inlet section and at least one liquid outlet section.

These sections may be multiple and may be in the following manner:
radially to the thruster,
parallel to the axis of movement of the thruster, and
by a combination of the two preceding possibilities.

According to a particular embodiment, the downstream cover comprises a central tube, extending coaxially to the electromagnetic machine. This feature makes it possible to create a second flow in a compression chamber through the placement of a tube passing through the compression chamber. The inlet section of this tube will experience a positive pressure and the outlet section (located downstream of the compression chamber), a negative pressure, thus creating a Venturi effect and improving the efficiency of the thruster.

According to other embodiments, the mechanical assembly may comprise no cover, or a single cover: an upstream cover or a downstream cover. In the absence of a cover, there is therefore no more compression chamber.

Other applications of the mechanical assembly proposed above are possible, for example, shaker units, industrial vibrators, pistons, in particular moving parts operating in phase to amplify the vibration, firing pins, loudspeakers, saws, picks, sex toys, tools for researching vibrations, fatigue, aging, industrial pumps, fans, air compressors, force returns, sieves, vibrators for vibratory hammering, boat and watercraft propellers, propellers for water toys, such as underwater propellers, paddles, motorized surfboards, bilge pumps, electricity generators, pumps for water games, flow generators (currents, waves, swell) for ponds, machine tools (such as saws, sanders, hammers), mixers.

According to a third aspect, a method is provided for actuating an electromagnetic machine according to the first aspect, the machine comprising:
a stator comprising at least four stator elements forming two pairs of stator elements, and
a linearly movable portion, comprising at least four rods forming at least two pairs of two rods,
the method comprising an actuation step phase-shifted between the at least two pairs of two rods.

### BRIEF DESCRIPTION OF THE DRAWINGS

The present disclosure will be better understood on reading the following description, in reference to non-limiting embodiments illustrated by the appended drawings, in which:

FIG. 1 is a perspective view of an electromagnetic machine with cyclic linear movement according to a first embodiment of the present disclosure, wherein the machine comprises a pair of stator elements and a pair of rods, the frame not being shown;

FIG. 2 is a profile view of two stator elements facing each other, each comprising a winding of electrical wires, the elements being in accordance with FIG. 1;

FIG. 3 is a perspective view of a linearly movable portion according to one embodiment, comprising two permanent magnets arranged between two rods;

FIG. 4 is a perspective view of an electromagnetic machine with cyclic linear movement according to a second embodiment of the present disclosure, wherein the machine comprises two pairs of stator elements and two pairs of rods arranged symmetrically with respect to a geometric plane passing through the longitudinal axis of the machine, the frame not being shown;

FIG. 5 is a perspective view of an electromagnetic machine with cyclic linear movement according to a third embodiment of the present disclosure, wherein the machine comprises three pairs of stator elements and three pairs of rods arranged relative to each other so as to form a circle, the frame not being shown;

FIG. 6 is a perspective view of an electromagnetic machine with cyclic linear movement according to a fourth embodiment of the present disclosure, wherein the machine comprises six pairs of stator elements and six pairs of rods arranged relative to each other so as to form a circle, the frame being shown;

FIG. 7 is a longitudinal sectional view of an electromagnetic machine, in particular of a linearly movable portion according to an embodiment according to the preceding figures;

FIG. 8 is a longitudinal sectional view of a hydraulic thruster according to a first embodiment, the thruster comprising an electromagnetic machine according to FIG. 7, and a single flange having a central opening and a single discoidal membrane having a central opening;

FIG. 9 is a perspective view of a hydraulic thruster according to the first embodiment;

FIG. 10 is a perspective view of a hydraulic thruster according to a second embodiment, the thruster comprising a single solid flange and comprising a tail with a conical shape and a single membrane having an opening;

FIG. 11 is a longitudinal sectional view of a hydraulic thruster according to the second embodiment, according to the preceding figures;

FIG. 12 is a cross-sectional view of a hydraulic thruster according to FIGS. 10 and 11 and an electromagnetic machine according to a fifth embodiment, the machine comprising four pairs of stator elements and four pairs of rods;

FIG. 13 is a profile view of an electromagnetic machine according to a sixth embodiment comprising upstream rods and downstream rods;

FIG. 14 is a profile view of an electromagnetic machine according to a seventh embodiment comprising rods that are both upstream and downstream;

FIG. 15 is a profile view of a nautical propulsion assembly comprising a hydraulic thruster according to FIG. 9;

FIG. 16 is a profile view of a hydraulic thruster according to a fourth embodiment, the thruster comprising an upstream cover and a downstream cover;

FIG. 17 is a longitudinal sectional view of a hydraulic thruster according to the preceding figures;

FIG. 18 is an enlarged partial view of FIG. 17, the upstream cover and the upstream membrane being illustrated in an enlarged manner;

FIG. 19 is a longitudinal sectional view of a hydraulic thruster according to a fifth embodiment, wherein the upstream cover comprises a front opening;

FIG. 20 is a longitudinal sectional view of a hydraulic thruster according to a sixth embodiment comprising upstream radial openings and downstream radial openings; and

FIG. 21 is a longitudinal sectional view of a hydraulic thruster according to a seventh embodiment comprising upstream radial openings, downstream radial openings, and a central tube passing through the upstream cover.

### DETAILED DESCRIPTION

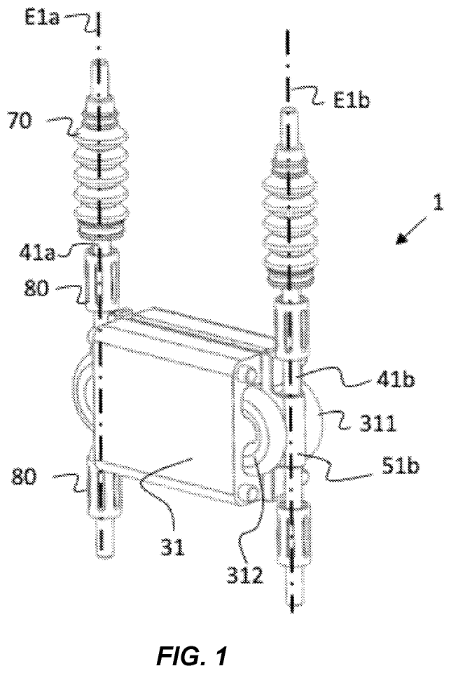

Referring to FIGS. 1, 2 and 3, a first embodiment of an electromagnetic machine 1 with cyclic linear movement is presented. In order to view as many parts as possible, the machine frame is not shown.

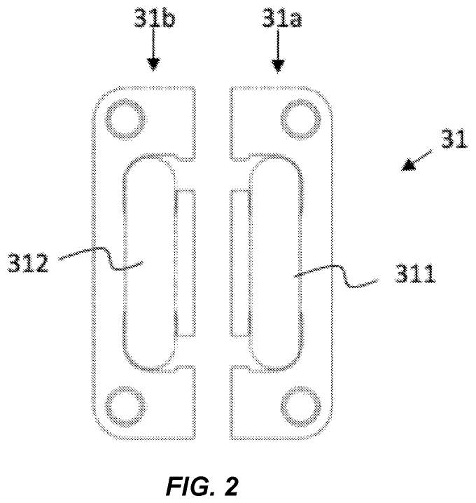

The machine comprises a static part 31, called a stator, arranged to create an electromagnetic field. Referring to FIG. 2, the stator comprises two stator elements 31a and 31b, forming a pair of stator elements. Each stator element comprises a stack of sheet metal plates arranged so as to form an “E”-shaped pattern. Each stator element comprises three teeth and two notches. Each stator element 31a, 31b further comprises an electrical winding 311, 312 inserted into the notches of a stack of sheet metal plates so as to form a loop. The stator elements 31a, 31b are arranged opposite and spaced apart from each other by a distance making it possible to insert at least one magnetic element of the movable portion and an air gap distance. With reference to FIGS. 1 and 2, the stator elements have a general shape and a rectangular cross section and extend rectilinearly.

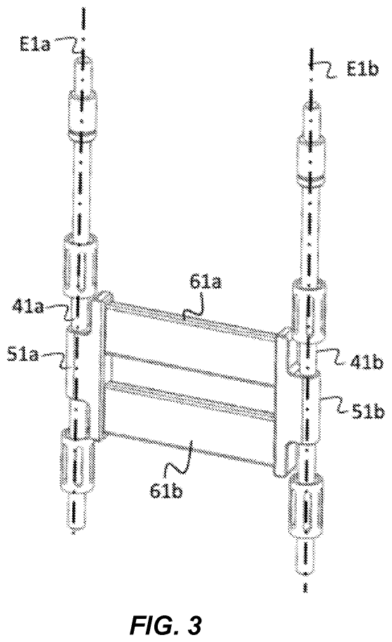

The machine comprises a linearly movable portion carrying out an alternating rectilinear translational movement. With reference to FIGS. 1 and 3, the movable portion comprises two distinct rods 41a, 41b movable along respective drive axes E1a, E1b, the axes extending along an axis or a longitudinal direction. They are arranged on either side of the stator 31, in particular between the two winding portions, in the shape of a semicircle, extending outside the stacks of sheet metal plates. The rods 41a, 41b have a circular cross-section. With reference to FIG. 3, the movable portion comprises two permanent magnets 61a, 61b arranged between the two rods 41a, 41b. The permanent magnets have a rectangular shape. They are arranged to be inserted between the two stator elements 31a, 31b so as to move magnetically during the switching of the stator elements. The two magnets 61a, 61b are spaced apart longitudinally so that the two magnets can align with two consecutive teeth of a stator element.

The movable portion further comprises coupling means 51a, 51b between permanent magnets 61a, 61b and rods 41a, 41b. Each coupling means 51a, 51b comprises a rod part arranged to be fastened to a rod so as to be integral in translation. The rod part surrounds the outer envelope of a rod. Each coupling means 51a, 51b comprises a part of a magnetic element arranged to receive and fasten the two magnets and thus mechanically couple the magnets to a rod.

Optionally, the machine comprises two guide parts 80, preferably cylindrical, serving as a translational guide for each rod. The two guide parts attach to the longitudinal ends of the frame. These guide parts are advantageously made of non-magnetic materials in order to minimize magnetic field leakage. These two parts have the other function of serving as a connecting part for any effector or movable portion that needs to be set into motion.

This first embodiment makes it possible to propose an electromagnetic machine that is compact. This first embodiment corresponds to an electromagnetic module so that an electromagnetic machine of greater electrical power can comprise several electromagnetic modules arranged in parallel.

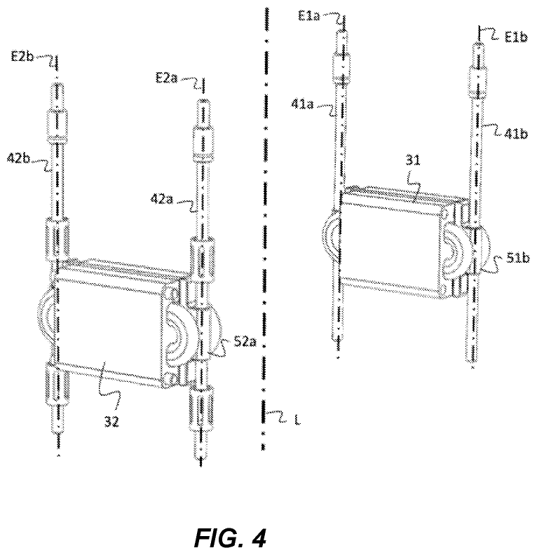

FIG. 4 shows a second embodiment of an electromagnetic machine comprising two electromagnetic modules, each module being in accordance with the module of the first embodiment. The electromagnetic machine comprises two pairs of stator elements 31, 32, the pair of stator elements 31 being associated with the pairs of rods 41a, 41b, and the pair of stator elements 32 being associated with the pairs of rods 42a, 42b. The electromagnetic machine extends along a longitudinal axis L. The respective drive axes of the rods are parallel to the longitudinal axis L of the machine. Furthermore, the two modules are arranged symmetrically relative to a geometric plane passing through the longitudinal axis L.

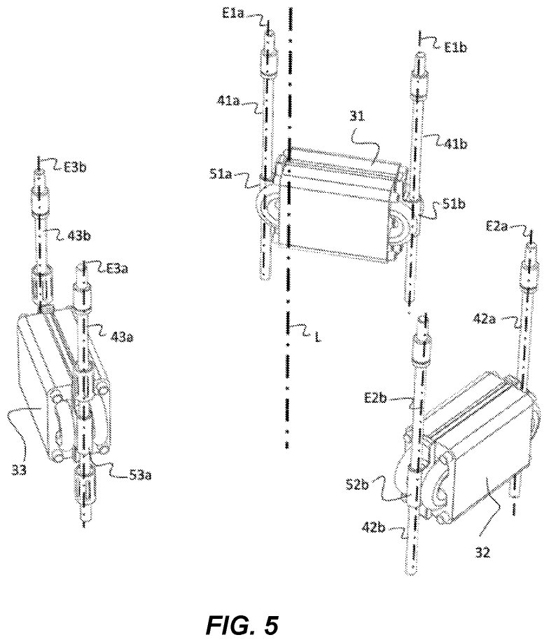

FIG. 5 shows a third embodiment of an electromagnetic machine comprising three electromagnetic modules, each module being in accordance with the module of the first embodiment. The electromagnetic machine comprises three pairs of stator elements 31, 32, 33, the pair of stator elements 31 being associated with the pairs of rods 41a, 41b, the pair of stator elements 32 being associated with the pairs of rods 42a, 42b, and the pair of stator elements 33 being associated with the pairs of rods 43a, 43b. The electromagnetic machine extends along a longitudinal axis L. The respective drive axes of the rods are parallel to the longitudinal axis L of the machine. Furthermore, the three modules are arranged along a circle whose longitudinal axis L is the center. The three electromagnetic modules are spaced equidistant.

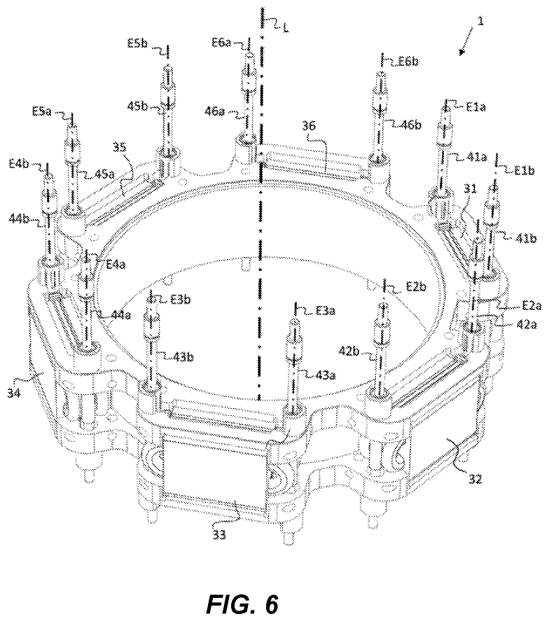

FIG. 6 shows a fourth embodiment of an electromagnetic machine comprising six electromagnetic modules, each module being in accordance with the module of the first embodiment. Unlike the embodiments presented above, the frame of the electromagnetic machine 1 is shown in FIG. 6. The electromagnetic machine comprises six pairs of stator elements 31, 32, 33, 34, 35 and 36, the pair of stator elements 31 being associated with the pairs of rods 41a, 41b, the pair of stator elements 32 being associated with the pairs of rods 42a, 42b, the pair of stator elements 33 being associated with the pairs of rods 43a, 43b, the pair of stator elements 34 being associated with the pairs of rods 44a, 44b, the pair of stator elements 35 being associated with the pairs of rods 45a, 45b, the pair of stator elements 36 being associated with the pairs of rods 46a, 46b. The electromagnetic machine extends along a longitudinal axis L. The respective drive axes of the rods are parallel to the longitudinal axis L of the machine. Furthermore, the six modules are arranged along a circle whose longitudinal axis L is the center. The three electromagnetic modules are spaced equidistant.

With reference to FIGS. 4, 5 and 6, the arrangement of the electromagnetic machines makes it possible to leave their central zone free. The central zone of each machine has a tubular shape, the axis of which corresponds to the longitudinal axis L.

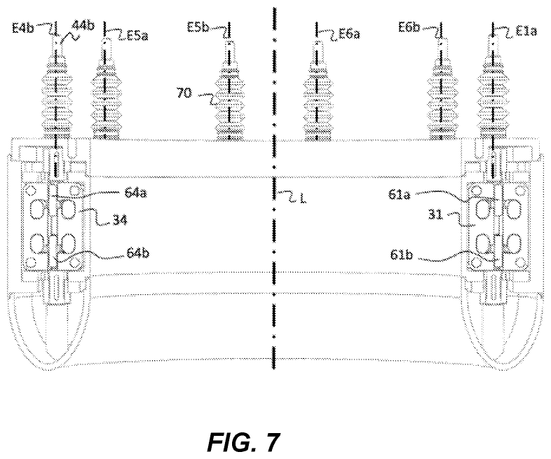

FIG. 7 shows a sectional view of an electromagnetic machine according to FIG. 6. The stator elements of the stator 34 and the stator elements of the stator 31 are seen in cross-section. Furthermore, the associated permanent magnets 64a, 64b and 61a, 61b are seen in cross-section. FIG. 7 furthermore shows two lids of the machine, a cover being arranged at each longitudinal end.

For the rest of the description, the operation and/or the movement of a rod will be described, in this case the rod 44b.

In an initial state, the position of the rod is such that the permanent magnets 64a, 64b are opposite teeth of the stator elements 34 because the magnetic fluxes induced in the air gaps are sufficient to achieve a polarity, for example, a north pole, on one side and a reverse polarity, for example, a south pole, on the other side. Since each permanent magnet has a reverse polarity, the magnetic fluxes pass through the permanent magnets and keep them in position.

During a switching of current into the coils, the magnetic fluxes in the air gaps are inverted so that each pole of a permanent magnet is opposite an identical polarity, producing a repulsion force and a translation of the magnets and therefore of the rod 44b. At the same time, the magnetic fluxes come to pass through the adjacent permanent magnets, of reverse polarities, so that an attraction force causes the rod 44b to move in translation. As a result, the new position (not shown) of the permanent magnets leads to a new position (not shown) of the rod 44b.

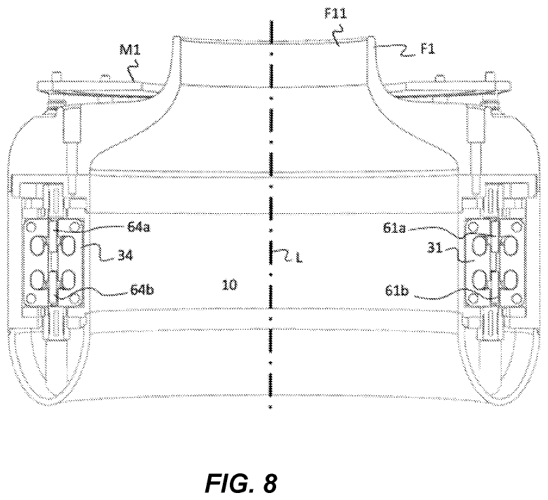

FIG. 8 is a sectional view of a hydraulic thruster comprising an electromagnetic machine according to FIG. 6, a flange F1 and a membrane M1, the flange and the membrane being arranged on the same end, called the downstream end, of the machine coaxially with respect to the longitudinal axis L. The opposite end, called the upstream end, has no wall preventing the circulation of a flow through the central zone 10 of the electromagnetic machine. In this embodiment, the thruster has the general shape of a tube.

The flange F1 has a central opening so that a flow can pass through it. The flange F1 has a first face, referred to as the connection face, arranged to be connected to an end of an electromagnetic machine, and a second face, referred to as the external face, opposite the connection face. The flange F1 has an inner surface in the form of a cone or nozzle, the largest diameter of the inner surface corresponding to the inner diameter of the electromagnetic machine. The flange further comprises a tubular portion F11 protruding from the external face.

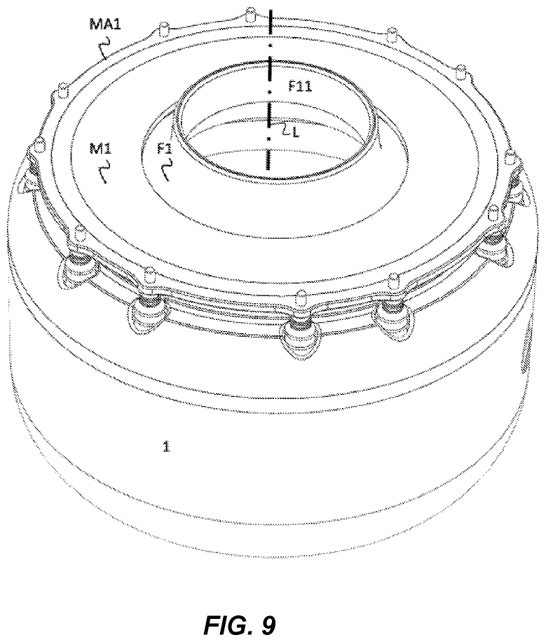

The membrane M1 has the shape of a ring and comprises an armature MA1 connected to all the distal ends of the rods of the electromagnetic machine, see FIG. 9. The membrane M1 has a central opening through which the tubular portion F11 of the flange F1 extends.

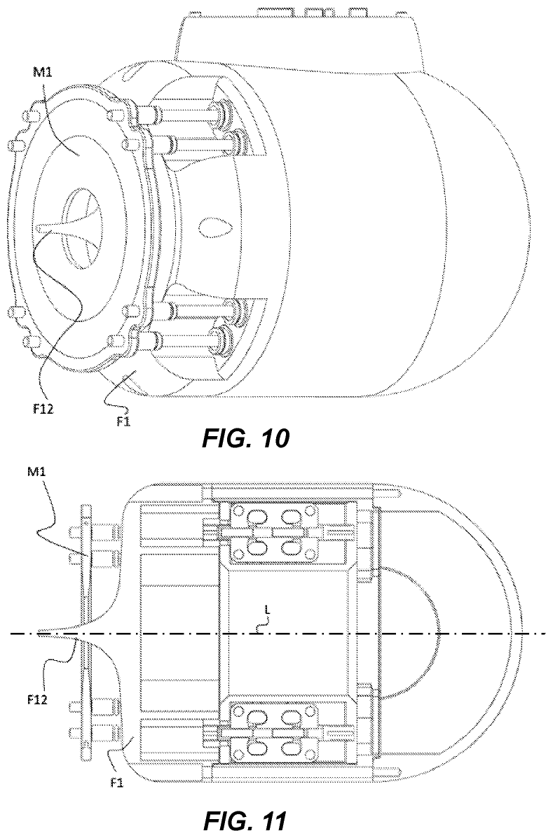

Referring to FIGS. 10 and 11, a second embodiment of a hydraulic thruster is shown. Compared to the preceding embodiment, the present thruster is closed at each end. At least one wall closes the central zone of the electromagnetic machine, so that the thruster has an oblong and/or ovoid general shape.

The flange F1 does not have a central opening. The flange F1 has a first face, referred to as the connection face, arranged to be connected to an end of an electromagnetic machine, and a second face, referred to as the external face, opposite the connection face. The flange further comprises a conical portion F12 protruding from the external face, the diameter of the cone reducing from the external face to the tip of the conical portion. The conical portion passes through the central opening of the membrane M1, see FIGS. 10 and 11.

The association of a flange F1 and a membrane M1 allows the propulsion of the hydraulic thruster.

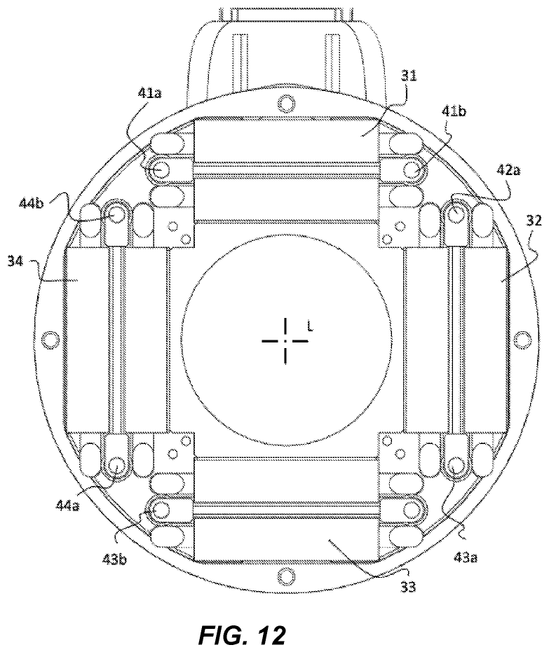

FIGS. 11 and 12 show a fifth embodiment of the electromagnetic machine. Referring to FIG. 12, the electromagnetic machine comprises four pairs of stator elements 31, 32, 33 and 34, the pair of stator elements 31 being associated with the pairs of rods 41a, 41b, the pair of stator elements 32 being associated with the pairs of rods 42a, 42b, the pair of stator elements 33 being associated with the pairs of rods 43a, 43b, the pair of stator elements 34 being associated with the pairs of rods 44a, 44b. The electromagnetic machine extends along a longitudinal axis L. The respective drive axes of the rods are parallel to the longitudinal axis L of the machine. Furthermore, the four modules are arranged along a circle whose longitudinal axis L is the center. The four electromagnetic modules are spaced equidistant.

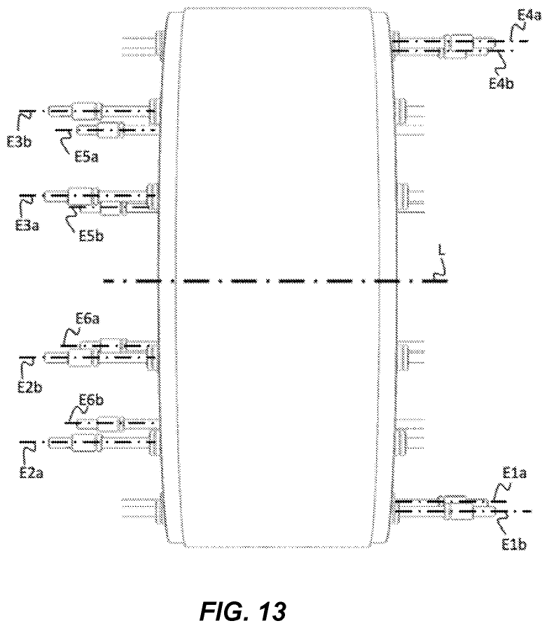

FIG. 13 shows a sixth embodiment of an electromagnetic machine, in particular combinable with one of the preceding embodiments due to the fact that each electromagnetic module can be controlled independently of the others. The electromagnetic machine comprises pairs of upstream rods extending from a first end of the machine. The machine further comprises pairs of downstream rods extending from a second end, opposite the first end, of the electromagnetic machine. FIG. 13 shows upstream rods extending along the axes E3a, E3b, E5a, E5b, E2a, E2b, E6a, E6b. It is also shown upstream rods extending along the axes E1a, E1b, E4a, E4b.

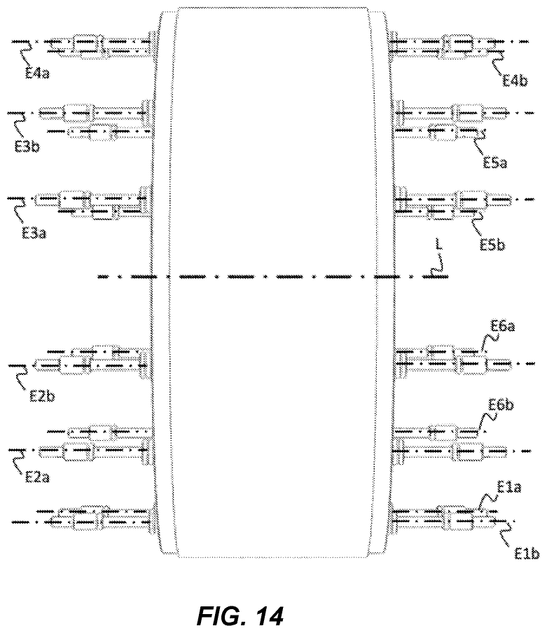

Alternatively, FIG. 14 shows a seventh embodiment of an electromagnetic machine, wherein each pair of rods passes through the frame of the machine in such a way as to pair upstream rods and a pair of downstream rods. This embodiment is in particular suitable for mechanical assemblies comprising an effector, for example, a membrane, at each end of the electromagnetic machine.

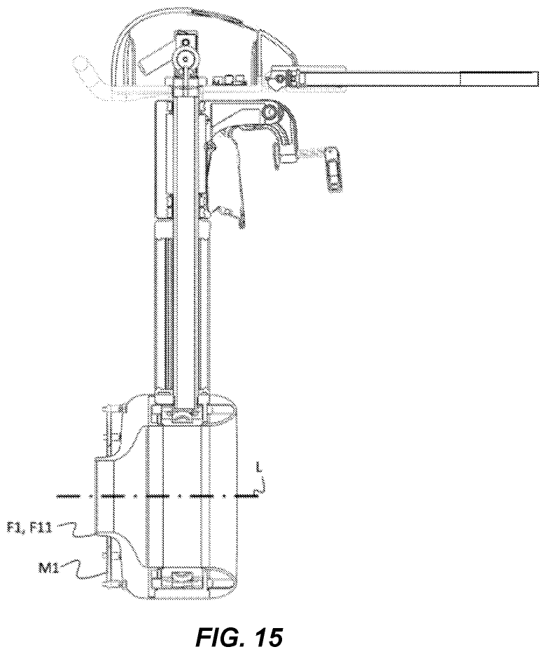

FIG. 15 shows an application wherein the hydraulic thruster according to FIG. 9 is connected to a steering and control device of a boat.

The thruster comprises control means and/or power electronics so that the motor is capable of being used in a wide range of use cases. For example, it can be powered by the grid, a solar panel array, or any other alternative energy installation or in an energy storage system with its connection through power electronics making it possible to regulate and control the electric current.

Depending on the type of control signal and its shape, the motor can fulfill different use cases: in a case of power supply by a continuous electrical voltage, the position of the motor is controlled. It will therefore maintain a precise and repeatable position according to the supplied electrical voltage value. In the case where an alternating voltage is provided, the speed of the motor will be controlled. The value of the electrical voltage makes it possible to adjust the amplitude of the stroke of the movable bars. As for the frequency of the electrical signal, it is possible to adjust the operating frequency of the motor.

The motor makes it possible to provide a linear high frequency movement, in particular up to 500 cycles per second, that is to say an operation at 500 Hz.

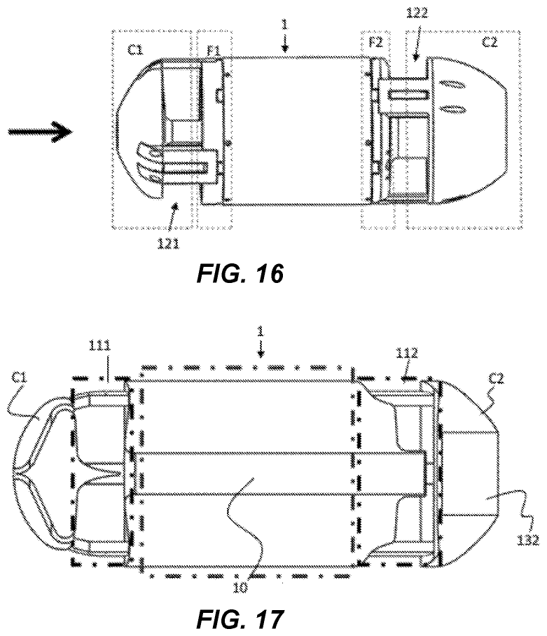

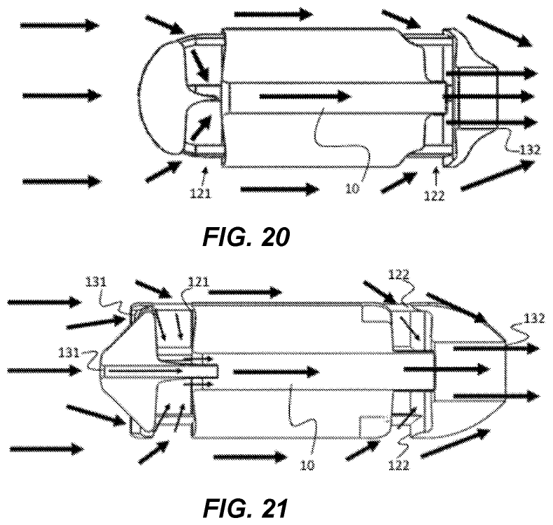

FIGS. 16 to 21 show several embodiments of hydraulic thruster arranged to be submerged.

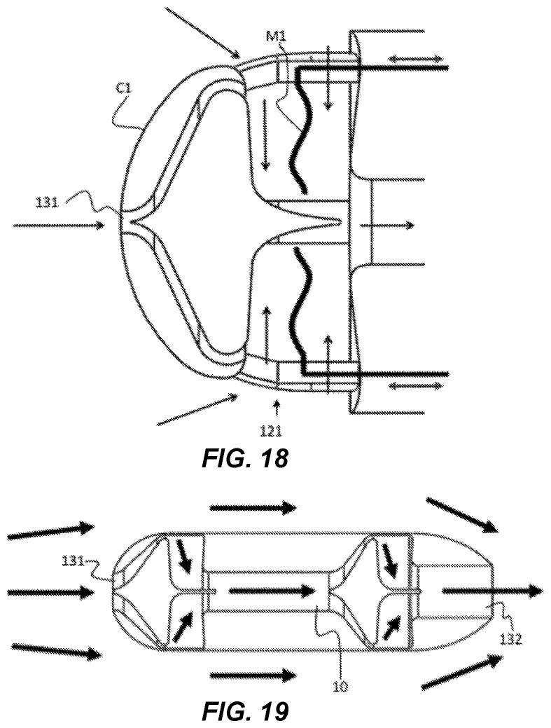

With reference to FIG. 16, the thruster comprises an upstream cover C1, arranged upstream of a first flange F1, and a downstream cover C2, arranged downstream of a second flange F2, the membranes not being shown. Each cover is attached to the frame of the electromagnetic machine coaxially to the longitudinal axis of the machine, for example, by way of longitudinal arms connecting each cover to the frame of the machine. With reference to FIG. 9, the volume defined longitudinally between a cover and a flange defines a compression chamber. An upstream compression chamber 111 is defined between the cover C1 and the electromagnetic machine 1. A downstream compression chamber 112 is defined between the cover C2 and the electromagnetic machine 1. Both when stopped and while the machine is in operation, each membrane is located in a compression chamber. For example, with reference to FIG. 18, the upstream membrane M1 is set in motion by way of rods of the movable portion of the electromagnetic machine, so as to oscillate. The liquid set in motion by a membrane enters the compression chamber beforehand.

With reference to FIGS. 16, 17, 18, 19, 20, 21, the thruster comprises upstream radial openings 121. With reference to FIGS. 16, 17, 20 and 21, the thruster comprises downstream radial openings 122. The radial openings are circumferentially delimited by the longitudinal arms connecting the covers to the frame of the machine. The radial openings allow the liquid to enter into each compression chamber.

The volume propelled by the upstream membrane is expelled into the central zone 10 of the machine. The volume of liquid propelled by the upstream membrane is expelled into the downstream compression chamber.

Furthermore, according to all the embodiments comprising a cover, the downstream cover C2 comprises an axial opening 132.

In these so-called parallel configurations, each compression chamber has an inlet flow specific to it, each flow entering the compression chamber via an opening or a radial zone. The downstream cover further comprises an opening whose cross-section is at least equal to the cross-section of the free central area.

Referring to FIG. 19, it is a configuration, called serial, in which the inlet flow of the downstream compression chamber is connected to the outlet flow of the upstream compression chamber via the free central zone of the machine. The thruster comprises a single inlet opening 131 for supplying liquid to the upstream compression chamber.

It is possible to combine these two solutions: an axial flow and a radial flow, to supply the compression chambers. With reference to FIG. 21, the upstream cover C1 comprises an opening 131 extending by a central tube that opens into the central zone 10 so as to produce a Venturi effect. According to another embodiment not shown, the tube can open into the upstream compression chamber. The thruster further comprises upstream radial openings 121 and downstream radial openings 122.

1. An electromagnetic machine, comprising:
a frame;
a stator arranged to create a magnetic field, the stator comprising at least two stator elements facing each other; and
a linearly movable portion, including:
at least two rods that are movable along respective drive axes, each rod being arranged at one end of the at least two stator elements,
at least one magnetic element associated with the at least two rods, the at least one magnetic element being arranged between the two stator elements and magnetically movable with respect to the at least two stator elements, and
coupling means between the at least one magnetic element and the rods.

2. The electromagnetic machine of claim 1, wherein each magnetic element comprises at least one pair of alternating poles.

3. The electromagnetic machine of claim 1, wherein the at least one magnetic element is at least one permanent magnet.

4. The electromagnetic machine of claim 3, further comprising at least one spacer arranged between two pairs of poles.

5. The electromagnetic machine of claim 1, wherein each stator element comprises a stack of sheet metal plates comprising at least two teeth.

6. The electromagnetic machine of claim 1, further comprising at least one position return means, associated with at least one rod.

7. The electromagnetic machine of claim 1, further comprising means for sealing the stator and/or the movable portion relative to the external environment.

8. The electromagnetic machine of claim 1, wherein the stator comprises at least four stator elements forming two pairs of two stator elements arranged around a longitudinal axis and extending in a circumferential or orthoradial direction relative to the longitudinal axis, and wherein the linearly movable portion comprises four rods forming two pairs of two rods.

9. The electromagnetic machine of claim 8, wherein the at least two pairs of stator elements are spaced along a circle whose longitudinal axis is the center.

10. The electromagnetic machine of claim 8, wherein the stator elements are arranged so as to define a free central area.

11. A mechanical assembly comprising an electromagnetic machine according to claim 1, and at least one effector mounted to at least one of the distal ends of the at least two rods.

12. The mechanical assembly of claim 11, wherein the at least one effector comprises at least one membrane.

13. A mechanical assembly comprising an electromagnetic machine according to claim 1 extending along a longitudinal axis, wherein:
the stator comprises at least four stator elements forming two pairs of stator elements; and
the linearly movable portion comprises at least four rods forming two pairs of two rods;
the mechanical assembly further comprising at least one effector mounted to the at least one of the distal ends of at least two rods.

14. The mechanical assembly of claim 13, wherein the at least four rods comprise at least two upstream rods and at least two downstream rods, the mechanical assembly further comprising an upstream membrane connected to the distal ends of the at least two upstream rods, and a downstream membrane connected to the distal ends of the at least two downstream rods.

15. The mechanical assembly of claim 13, wherein at least two rods of a pair of the two pairs of rods extend both upstream and downstream of the frame, the mechanical assembly further comprising at least two effectors including an upstream effector connected to the upstream distal ends of the rods and a downstream effector connected to the downstream distal ends of the rods.

16. A method for operating an electromagnetic machine according to claim 1, wherein:
the stator comprises at least four stator elements forming two pairs of stator elements; and
the linearly movable portion comprises at least four rods forming at least two pairs of two rods;
the method comprising an actuation step phase-shifted between the at least two pairs of two rods.
